(19) United States
(12) Patent Application Publication
(10) Pub. No.: US 2005/0007484 A1
(43) Pub. Date: Jan. 13, 2005

(54) Digital image capturing module assembly and method of fabricating the same

(75) Inventors: Kah-Ong Tan, Shanghai (CN); Jia Shi, Shanghai (CN)

Correspondence Address: Mr. Peter F. Corless;EDWARDS & ANGELL, LLP, 101 Federal Street, Boston, MA, 02110-1800, US

(73) Assignee: Inventec Micro-Electronic Corporation

(21) Appl. No.: 10/618,434

(22) Filed: Jul. 10, 2003

(51) Int. Cl. H04N 5/225

(52) U.S. Cl. 348/340

(57) ABSTRACT

A digital image capturing module assembly and method of fabricating the same is proposed, which is used for the assembly of a digital image capturing module from a photosensitive printed circuit board and a lens holder. The proposed module assembly is characterized by the use of aligning posts on the lens holder to help align and secure the photosensitive printed circuit board in position on the lens holder as well as by the use of a washer to help provide a sealed light-impenetrable effect at the junction between the photosensitive printed circuit board and the lens holder so that no sidelight can pass therethrough to the inside of the lens holder. This feature allows the assembly process to be more simplified and less time-consuming to implement than prior art, which can help increase the yield of the assembly of digital image capturing module.

### BACKGROUND OF THE INVENTION

1. Field of the Invention

This invention relates to electronics assembly technology, and more particularly, to a digital image capturing module assembly and method of fabricating the same, which is designed for use to assemble a digital image capturing module by mounting a photosensitive printed circuit board (PCB), such as a CCD (Charge Coupled Device) based photosensitive printed circuit board, on a lens holder.

2. Description of Related Art

Digital image capturing module is a key component in the assembly of a digital still camera (DSC) or a camera-equipped electronic device such as mobile phone, which is composed of a lens holder and a photosensitive printed circuit board (PCB); wherein the lens holder is used to hold a lens unit that is used to capture an optical image and focus the captured image on a focusing plane on the rear side of the lens holder, while the photosensitive printed circuit board is, for example, a CCD (Charge Coupled Device) based PCB, and which is disposed on the focusing plane of the lens holder for the purpose of converting the optical image focused thereon into digital form.

A conventional method for the assembly of a digital image capturing module from a lens holder and a photosensitive printed circuit board is to use an adhesive agent to adhere the photosensitive printed circuit board to the rear side of the lens holder. After the adhesive agent is cured, it can firmly secure the photosensitive printed circuit board in position on the lens holder as well as provide a sealed light-impenetrable effect at the junction between the photosensitive printed circuit board and the lens holder to prevent undesired sidelight effect to the digital image capturing module that would otherwise degrade the quality of the captured image.

One drawback to the foregoing assembly method, however, is that the coating of the adhesive agent over the lens holder requires the use of precision coating equipment to achieve, which is undesirably quite complex in procedure and time-consuming to implement. Moreover, the baking process to cure the adhesive agent is also quite time-consuming. These drawbacks make the assembly of digital image capturing modules quite low in yield.

### SUMMARY OF THE INVENTION

It is therefore an objective of this invention to provide a new digital image capturing module assembly and method of fabricating the same which can help simplify the assembly process and reduce the required assembly time so that the assembly of digital image capturing modules can be increased in yield.

The digital image capturing module assembly and method of fabricating the same according to the invention is designed for use to assemble a digital image capturing module by mounting an optical sensing PCB (printed circuit board), such as CCD (Charge Coupled Device) based PCB, to a lens holder.

The digital image capturing module assembly and method of fabricating the same according to the invention is characterized by the use of aligning posts to help align and secure the photosensitive printed circuit board in position on the lens holder as well as by the use of a washer to help provide a sealed light-impenetrable effect at the junction between the photosensitive printed circuit board and the lens holder so that no sidelight can pass therethrough to the inside of the lens holder. This feature allows the assembly process to be implemented without having to coat adhesive agent, and therefore allows the assembly process to be more simplified and less time-consuming to implement, which can help increase the yield of the assembly of digital image capturing module.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an exploded perspective view of the various constituent parts used to assemble a digital image capturing module according to the invention;

FIG. 2 is a schematic diagram showing a perspective view of the assembly of the digital image capturing module according to the invention;

FIG. 3 is a schematic sectional diagram used to depict a heating process in the assembly of the digital image capturing module according to the invention; and

FIG. 4 is a schematic diagram showing a sectional view of the finished product of the digital image capturing module according to the invention.

### DETAILED DESCRIPTION OF PREFERRED EMBODIMENTS

The digital image capturing module assembly and method of fabricating the same according to the invention is disclosed in full details by way of preferred embodiments in the following with reference to the accompanying drawings.

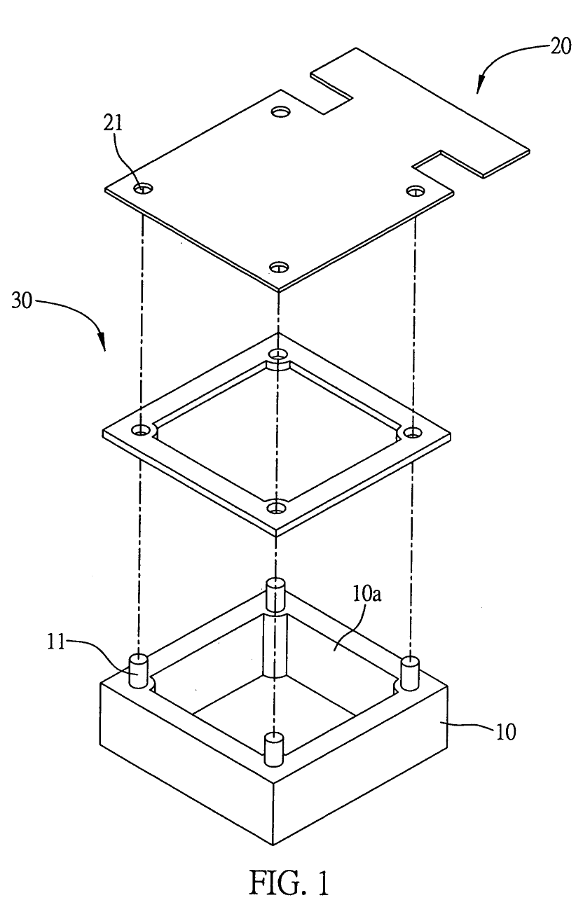

Referring first to FIG. 1, the initial steps in the assembly of a digital image capturing module according to the invention is to prepare a lens holder 10, a photosensitive printed circuit board 20, and a ring-shaped washer 30.

The lens holder 10 is used for the accommodation of a lens unit (not shown) therein, and the lens unit is to be used to capture an optimal image and focus the captured image on a focusing plane 10a on the rear side of the lens holder 10. This invention is characterized in that the lens holder 10 is formed with a plurality of aligning posts, for example 4 aligning posts 11, on the periphery of the focusing plane 10a. These aligning posts 11 are made of a thermally-meltable material, such as plastics, that can be melted when subjected to heat. Moreover, the aligning posts 11 should be each greater in length than the total thickness of the photosensitive printed circuit board 20 and the washer 30.

The photosensitive printed circuit board 20 is, for example, a CCD (Charge Coupled Device) based printed circuit board or the like, and which is to be used to convert the optical image captured by the lens unit (not shown) in the lens holder 10 into digital form. The photosensitive printed circuit board 20 is formed with a plurality of aligning holes 21 on the periphery thereof, whose size and position are correspondingly mapped to the aligning posts 11 on the lens holder 10.

The washer 30 is made of a flexible material, such as rubber, and is ring-shaped corresponding to the shape of the longitudinal cross section of the lens holder 10. Preferably, the washer 30 is also formed with a plurality of aligning holes 31 whose size and position are correspondingly mapped to the aligning posts 11 on the lens holder 10. Alternatively, the washer 30 can be formed with no aligning holes, but doing so is more preferable.

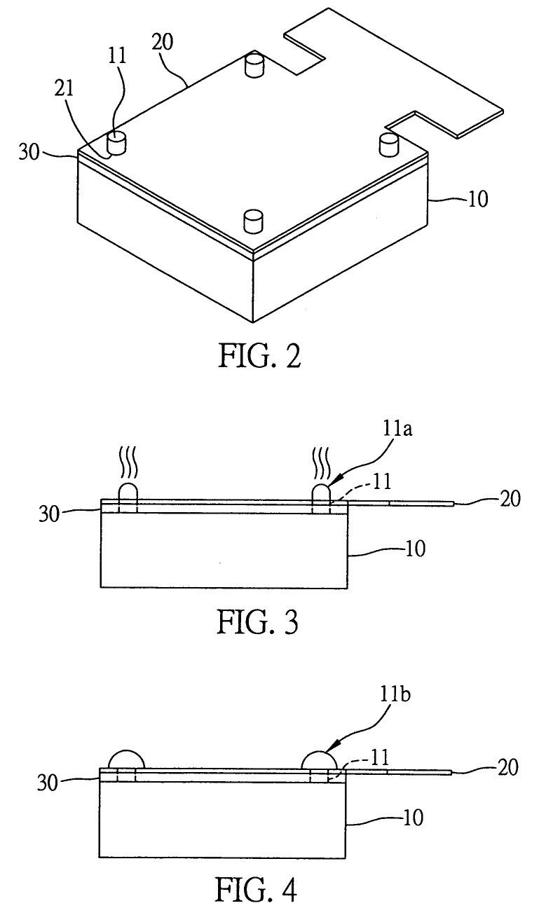

Referring to FIG. 2, during the assembly process, the first step is to mount the washer 30 in position on the periphery of the focusing plane 10a of the lens holder 11 (if the washer 30 has aligning holes, then the aligning holes 31 are fitted respectively to the aligning posts 11 on the lens holder 10); and then the photosensitive printed circuit board 20 is mounted in position on the washer 30 on the lens holder 10 by fitting the aligning holes 21 in the photosensitive printed circuit board 20 to the aligning posts 11 on the lens holder 10.

In the foregoing mounting procedure, since the aligning posts 11 are each greater in length than the total thickness of the photosensitive printed circuit board 20 and the washer 30, the respective tips 11a of the aligning posts 11 will be protruding over the photosensitive printed circuit board 20.

Referring next to FIG. 3, in the subsequent step, a pressing force (as indicated by the arrow in FIG. 3) is applied against the periphery of the photosensitive printed circuit board 10, and meanwhile a heating process is performed to heat against the protruding tips 11a of the aligning posts 11 for the purpose of melting the protruding tips 11a of the aligning posts 11.

Referring further to FIG. 4, after the protruding tips 11a of the aligning posts 11 has been melted and cured, they are each transformed into a bolting structure 11b which can help secure the photosensitive printed circuit board 20 firmly in position on the lens holder 10. Moreover, since the firmly-secured photosensitive printed circuit board 20 can forcefully press against the underlying washer 30, it allows the washer 30 to provide a sealed light-impenetrable effect at the junction between the photosensitive printed circuit board 20 and the lens holder 10 so that no sidelight can pass therethrough to the inside of the lens holder 10. This completes the assembly of the digital image capturing module according to the invention.

In conclusion, the invention provides a digital image capturing module assembly and method of fabricating the same for use to assemble a digital image capturing module by mounting a photosensitive printed circuit board to a lens holder, and which is characterized by the use of aligning posts to help align and secure the photosensitive printed circuit board in position on the lens holder as well as by the use of a washer to help provide a sealed light-impenetrable effect at the junction between the photosensitive printed circuit board and the lens holder so that no sidelight can pass therethrough to the inside of the lens holder. This feature allows the assembly process to be implemented without having to coat adhesive agent, and therefore allows the assembly process to be more simplified and less time-consuming to implement, which can help increase the yield of the assembly of digital image capturing module. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A digital image capturing module assembly, which comprises:
a lens holder, which has one side defined as a focusing plane, and which is formed with a plurality of aligning posts on the periphery of the focusing plane;
a washer, which is mounted on the periphery of the focusing plane of the lens holder; and
a photosensitive printed circuit board, which is formed with a plurality of aligning holes corresponding to the aligning posts on the lens holder, and which is mounted on the washer on the lens holder by fitting the aligning holes thereof to the aligning posts on the lens holder;
wherein
the respective tips of the aligning posts on the lens holder are each melted into a bolting structure to secure the photosensitive printed circuit board firmly in position on the lens holder;
and wherein
the firmly-secured photosensitive printed circuit board forcefully presses against the washer to thereby allow the washer to provide a sealed light-impenetrable effect at the junction between the photosensitive printed circuit board and the lens holder.

2. The digital image capturing module assembly of claim 1, wherein the photosensitive printed circuit board is a CCD-based photosensitive printed circuit board.

3. The digital image capturing module assembly of claim 1, wherein the aligning posts on the lens holder are made of plastics.

4. The digital image capturing module assembly of claim 1, wherein the washer is made of rubber.

5. The digital image capturing module assembly of claim 1, wherein the washer is formed with a plurality of aligning holes which are fitted to the aligning posts on the lens holder to help the washer secured in position on the lens holder.

6. A method for fabricating a digital image capturing module, comprising:
preparing a lens holder which has one side defined as a focusing plane, and which is formed with a plurality of aligning posts on the periphery of the focusing plane;
preparing a photosensitive printed circuit board which is formed with a plurality of aligning holes corresponding to the aligning posts on the lens holder;
mounting a washer on the periphery of the focusing plane of the lens holder;
mounting the photosensitive printed circuit board in position on the washer on the lens holder by fitting the aligning holes in the photosensitive printed circuit board to the aligning posts on the lens holder;
melting the respective tips of the aligning posts on the lens holder so as to transform the respective tips of the aligning posts into a bolting structure to secure the photosensitive printed circuit board in position on the lens holder as well as to allow the photosensitive printed circuit board to forcefully presses against the washer to thereby allow the washer to provide a sealed light-impenetrable effect at the junction between the photosensitive printed circuit board and the lens holder.

7. The method of claim 6, wherein the photosensitive printed circuit board is a CCD-based photosensitive printed circuit board.

8. The method of claim 6, wherein the aligning posts on the lens holder are made of plastics.

9. The method of claim 6, wherein the washer is made of rubber.

10. The method of claim 6, wherein the washer is formed with a plurality of aligning holes which are fitted to the aligning posts on the lens holder to help the washer secured in position on the lens holder.
